(19) United States
(12) Patent Application Publication
(10) Pub. No.: US 2025/0070497 A1
(43) Pub. Date: Feb. 27, 2025

(54) INSERTION TERMINAL AND INSERTION TERMINAL MOUNTING STRUCTURE

(71) Applicant: Changchun Jetty Automotive Technology Co., Ltd., Changchun, Jilin Province (CN)

(72) Inventors: Chao WANG, Changchun (CN); Zhenfang ZUO, Changchun (CN)

(21) Appl. No.: 18/721,095

(22) PCT Filed: Dec. 22, 2022
(86) PCT No.: PCT/CN2022/140902

§ 371 Date: Jun. 17, 2024

(30) Foreign Application Priority Data
Dec. 23, 2021 (CN) 202123264258.7

(51) Int. Cl. H01R 13/424; H01R 13/11; H01R 13/115

(52) U.S. Cl. CPC H01R 13/424; H01R 13/113; H01R 13/115

(57) ABSTRACT

The present disclosure provides a plug-in terminal and a plug-in terminal mounting structure. The plug-in terminal includes: a plurality of laminated terminals stacked in a transverse direction, each of the laminated terminals includes: a laminate base body and plug-in arms longitudinally extending from one end of the laminate base body and disposed to be paired, with a plug-in space formed between the paired plug-in arms; a contact portion protruding toward the plug-in space and a protruding cantilever with elastic are sequentially disposed from a free end of the plug-in arm to the laminate base body; a plurality of the plug-in spaces are stacked in the transverse direction to form a plug-in groove, the plug-in groove is configured to interface with a mating terminal to realize an electrical connection between the plug-in terminal and the mating terminal. By assembling the plurality of sheet-like laminated terminals together, the current carrying capacity is strong and the plug-in terminal is conveniently to be assembled, so that the overall structure is simple and the maintenance cost is low.

### RELATED APPLICATION

The present disclosure claims the priority of a Chinese utility model patent application with an application number of 202123264258.7, a patent title of “insertion terminal and insertion terminal mounting structure” and filed on Dec. 23, 2021, the entire content of which is incorporated herein.

### TECHNICAL FIELD

The present disclosure relates to the technical field of electrical connections, and particularly to a plug-in terminal and a plug-in terminal mounting structure.

### BACKGROUND

In the practical application of a high voltage connector, contacts are key components of connectors. Most of the existing terminals are formed by machining, which not only leads to a high cost and a low production efficiency, but also has a limited current carrying capacity. With the same contact area and current carrying capacity, owing to the processing mode, a sheet terminal is not only far lower in cost and weight than a circular terminal, but also has a good current carrying capacity, and it is the mainstream development trend of the future connector industry. In addition, most of the existing sheet terminals are fixed by welding, which is difficult for later maintenance at certain extent.

### SUMMARY

The present disclosure aims to provide a plug-in terminal and a plug-in terminal mounting structure, in which a plurality of sheet-like laminated terminals are assembled together, and a contact portion and a cantilever are disposed on a plug-in arm, thereby increasing the contact area between the laminated terminal and a mating terminal. This design not only achieves a strong current carrying capacity, but also enables the plug-in terminal to be conveniently assembled, so that the whole structure is simple and the maintenance cost is low.

The above objective of the present disclosure can be achieved using the following

### Technical Solutions

An embodiment of a first aspect of the present disclosure provides a plug-in terminal, comprising a plurality of laminated terminals stacked in a transverse direction, each of the laminated terminals includes: a laminate base body and plug-in arms longitudinally extending from one end of the laminate base body and disposed to be paired, with a plug-in space formed between the paired plug-in arms: a contact portion protruding toward the plug-in space and a protruding cantilever with elastic are sequentially disposed from a free end of the plug-in arm to the laminate base body: a plurality of the plug-in spaces are stacked in the transverse direction to form a plug-in groove, the plug-in groove is configured to interface with a mating terminal to realize an electrical connection between the plug-in terminal and the mating terminal.

Further, each of the laminated terminals further includes the plug-in arms extending longitudinally from the other end of the laminate base body and disposed to be paired.

Further, the contact portions in the laminated terminal are symmetrically disposed.

Further, the cantilevers in the laminated terminal are symmetrically disposed.

Further, the cantilever extends from a free end of the plug-in arm toward the laminate base body.

Further, a bent portion is disposed on a side at the free end of the cantilever, and an outer side of the bent portion faces the plug-in space.

Further, a minimum distance between the bent portions is less than or equal to a minimum distance between the contact portions.

Further, one end of each of the laminate base bodies includes at least one pair of buckle recesses which are oppositely disposed: the buckle recesses of the plurality of laminate base bodies are stacked in the transverse direction to form a corresponding buckle groove: the plug-in terminal further includes at least one pair of first buckles, each of which includes a fixing portion and holding portions disposed at two ends of the fixing portion: the fixing portions of one pair of the first buckles are respectively buckled in the corresponding buckle grooves, and the holding portions of at least one pair of the first buckles are mutually clamped to fix the plurality of laminated terminals together.

Further, two ends of each of the laminate base bodies are respectively provided with opposite buckle recesses, a fixing recess is further disposed between the buckle recesses at the two ends of each of the laminate base bodies, and two pairs the of buckle recesses of the plurality of laminate base bodies are stacked in the transverse direction to form corresponding buckle grooves, and the fixing recesses of the plurality of laminate base bodies are stacked in the transverse direction to form a fixing groove: the plug-in terminal further includes a pair of second buckles, each of which includes a fixing portion and holding portions disposed at two ends of the fixing portion, in which the fixing portion has a hollow structure that divides the fixing portion into a first fixing portion and a second fixing portion which are respectively buckled in the corresponding buckle grooves, and the holding portions on the same side of one pair of the second buckles are clamped with each other to fix the plurality of laminated terminals together, and in which the fixing groove is exposed through the hollow structure.

An embodiment of a second aspect of the present disclosure provides a plug-in terminal mounting structure, comprising fixing sidewalls which are oppositely disposed and the plug-in terminal according to the embodiment of the first aspect, in which inner sides of the fixing sidewalls are respectively provided with extended elastic pieces, ends of the elastic pieces are respectively provided with protruding fixing blocks, and the fixing blocks are cooperatively connected to the fixing groove.

The present disclosure has the following characteristics and advantages:
1. The plug-in arm of the plug-in terminal is provided with the cantilever, which increases contact points between the plug-in terminal and the mating terminal and then increases the contact area between the plug-in terminal and the mating terminal.
2. A direction in which the cantilever extends from the free end of the plug-in arm toward the laminate base body is a direction in which the mating terminal is plugged into the plug groove. In practical application, the failure of the cantilever caused by the oblique plug-in of the mating terminal is avoided, thereby preventing the electrical contact between the plug-in terminal and the mating terminal from being affected.
3. The laminated terminals are fixed by buckles after being stacked, which prevents the laminated terminals from rotating and fixes the laminated terminals, and the buckles may be made of a plastic material or any other hard material, thereby saving the cost.
4. When the mating terminal is plugged into the plug-in terminal, the plug-in arm stretches, and a tension on the laminate base body will be transferred through the first buckle. By disposing the buckle, the plug-in arm can be supported to avoid the failure of the plug-in terminal caused by excessive plug-in and unplug-in of the mating terminal.
5. Since the inner side of the fixing sidewall is provided with the elastic piece, when the mating terminal is plugged into the plug-in terminal, the elastic piece contracts, so that the fixing groove also contracts, thereby fixing and supporting the plug-in terminal.
6. The plug-in terminal is cooperated with the fixing block of the elastic piece, and is detachable during mounting due to the elastic effect of the elastic piece, thereby saving the cost of the later maintenance.
7. After the plug-in terminal is mounted on an insulator, it can be plugged into the mating terminal in the directions of 90° and 180°, thereby achieving the adaption with the high-current mating terminal.

### BRIEF DESCRIPTION OF THE DRAWINGS

In order to more clearly explain the technical solutions in the embodiments of the present disclosure, the drawings to be used in the description of the embodiments will be briefly introduced as follows. Obviously, the drawings used in the following description only illustrate some embodiments of the present disclosure, and those of ordinary skill in the art can obtain other drawings from them without paying any creative effort.

FIG. 1 illustrates a schematic diagram of a structure of a laminated terminal according to an embodiment of the present disclosure;

FIG. 2 illustrates a schematic diagram of a planar structure of the laminated terminal of FIG. 1;

FIG. 3 illustrates a schematic diagram of a structure of a plug-in terminal composed of the laminated terminals of FIG. 1;

FIG. 4 illustrates a schematic diagram of a structure of a laminated terminal according to another embodiment of the present disclosure;

FIG. 5 illustrates a schematic diagram of a planar structure of the laminated terminal of FIG. 4;

FIG. 6 illustrates a schematic diagram of a structure of a plug-in terminal composed of the laminated terminals of FIG. 4 and a first buckle;

FIG. 7 illustrates a schematic diagram of a plug-in terminal composed of the laminated terminals of FIG. 4 and a second buckle;

FIG. 8 illustrates a schematic diagram of a structure of the laminated terminals of FIG. 4 which are stacked together;

FIG. 9 illustrates a schematic diagram of a structure of a first buckle;

FIG. 10 illustrates a schematic diagram of a structure of a second buckle;

FIG. 11 illustrates a schematic diagram of a mounting structure for a plug-in terminal and a fixing sidewall;

FIG. 12 illustrates a schematic diagram of a structure of a fixing sidewall;

FIG. 13 illustrates a schematic diagram of a mounting structure for a terminal mounting structure and a mating terminal in a direction of 180°;

FIG. 14 illustrates a schematic diagram of a mounting structure for a terminal mounting structure and a mating terminal in a direction of 90°; and

FIG. 15 illustrates a plan view of a mounting structure for a terminal mounting structure and a mating terminal.

### REFERENCE NUMERALS

100: plug-in terminal;
10: laminated terminal;
11: laminate base body;
12: plug-in arm;
13: plug-in space;
14: buckle recess;
15: fixing recess;
121: contact portion;
122: cantilever;
1221: bent portion;
23: plug-in groove;
24: buckle groove;
25: fixing groove;
30: first buckle;
301: fixing portion;
302: holding portion;
31: second buckle;
311: first fixing portion;
312: second fixing portion;
32: hollow structure;
40: fixing sidewall;
41: elastic piece;
42: fixing block;
200: mating terminal.

### DETAILED DESCRIPTION OF THE PREFERRED EMBODIMENTS

The technical solutions in the embodiments of the present disclosure will be clearly and completely described below in conjunction with the drawings for the embodiments of the present disclosure. Obviously, those described are merely apart, rather than all, of the embodiments of the present disclosure. Based on the embodiments of the present disclosure, any other embodiment obtained by those of ordinary skill in the art without paying any creative effort should fall within the protection scope of the present disclosure.

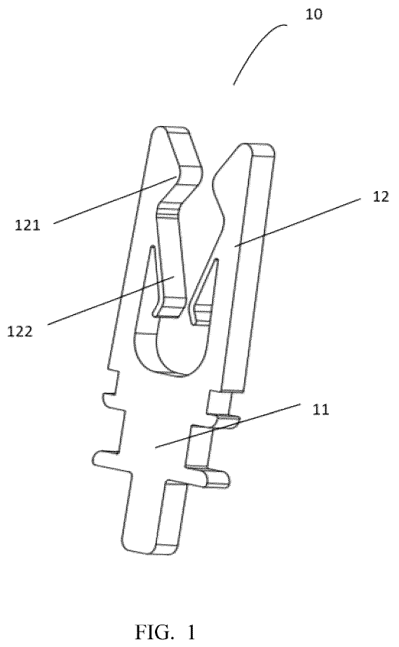

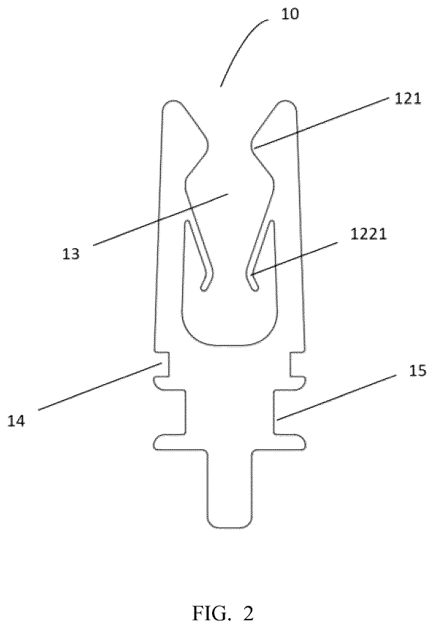

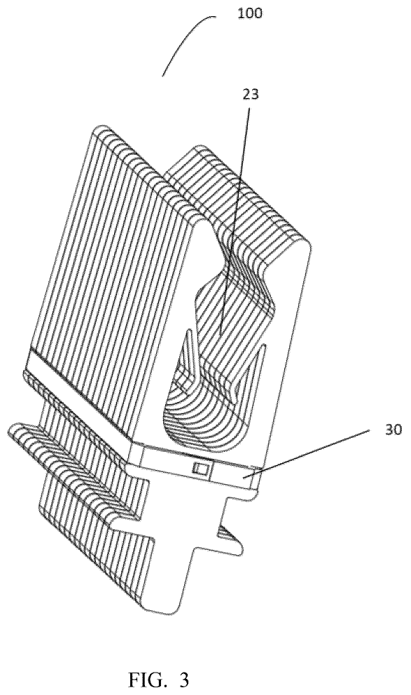

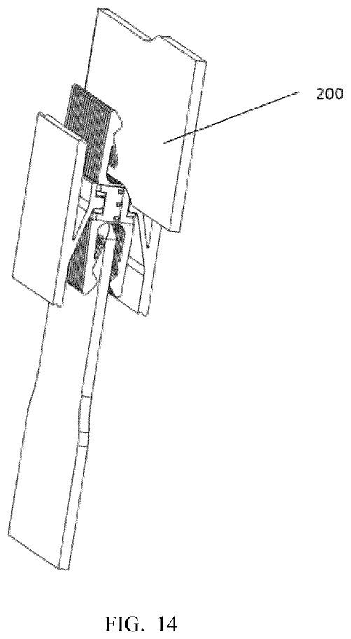

As illustrated in FIGS. 1 to 3, an embodiment of a first aspect of the present disclosure provides a plug-in terminal 100, which includes a plurality of laminated terminals 10 stacked in a transverse direction, each of the laminated terminals 10 includes a laminate base body 11 and plug-in arms 12 longitudinally extending from one end of the laminate base body 11 and disposed to be paired, such as two oppositely disposed plug-in arms 12, with a plug-in space 13 formed between the paired plug-in arms 12: a contact portion 121 protruding toward the plug-in space 13 and a protruding cantilever with elastic 122 are sequentially disposed from a free end of the plug-in arm 12 to the laminate base body 11: the plug-in spaces 13 are stacked in the transverse direction to form a plug-in groove 23, the plug-in groove 23 is configured to interface with a mating terminal 200 (FIG. 13) to realize an electrical connection between the plug-in terminal 100 and the mating terminal 200; and the transverse direction is a stacking direction of the laminated terminals 10 as illustrated in FIG. 3.

The plug-in arm 12 of each of the laminated terminals 10 of the plug-in terminal 100 is provided with the cantilever 122, which increases contact points between the plug-in terminal 100 and the mating terminal 200 and then increases the contact area between the plug-in terminal 100 and the mating terminal 200.

When the mating terminal 200 is plugged into the plug-in terminal 100, the contact portion 121 and the cantilever 122 are in contact with the mating terminal 200 and realize an electrical connection, thereby ensuring the connection reliability and the conductive effect. The plug-in terminal 100 is composed of a plurality of the laminated terminals 10, which can ensure a stable clamping structure, reduce the deformation and increase the strength of the plug-in arm 12.

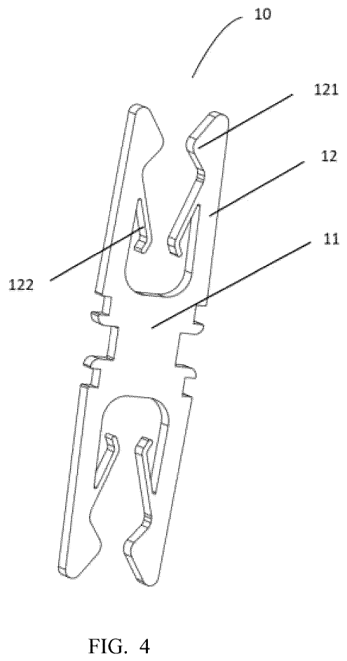

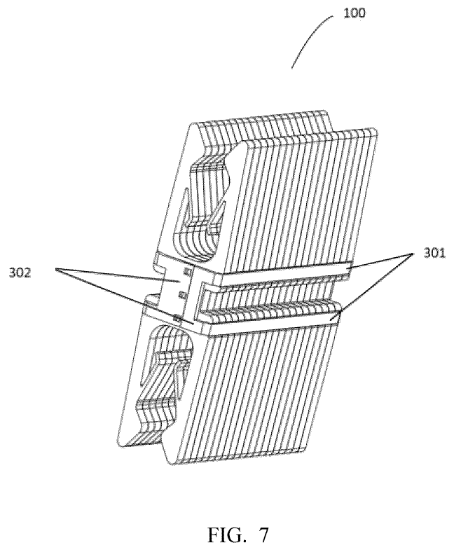

In an embodiment, as illustrated in FIGS. 4 to 7, each of the laminated terminals 10 further includes the plug-in arms 12 extending longitudinally from the other end of the laminate base body 11 and disposed to be paired, such as another two oppositely disposed plug-in arms 12. By disposing the plug-in arms 12 on the two ends of the laminate base 11 respectively, the laminated terminal 10 can be plugged with the mating terminal 200 in two opposite directions.

The laminated terminal 10 may be formed by be punching or cutting a plate and has a sheet shape. The laminated terminals 10 are distributed in a stacked state in the plug-in terminal 100, so that the plug-in terminal 100 has a high mechanical connection performance, while ensuring the conductive connection performance between the plug-in terminal 100 and the mating terminal 200. The punching or cutting of the plate is simple and the process is mature, so that the laminated terminals 10 can be quickly machined in large quantities, thereby saving the machining cost and improving the production efficiency. The mating terminal 200 cooperated with the plug-in terminal 100 may have a sheet shape or a plate shape. By adjusting the width of the plug-in arm 12 or the number of the laminated terminals 10, the clamping force can be controlled to facilitate the match with the mating terminal 200 and meet various plug-in requirements. By disposing the plug-in arms 12 of different sizes, it is possible to adapt to the mating terminals 200 of different shapes.

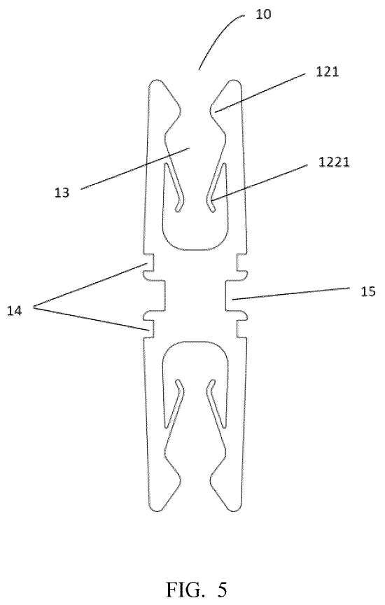

In an embodiment, as illustrated in FIGS. 4 and 5, the contact portions 121 in the laminated terminal 10 are symmetrically disposed. Therefore, when the mating terminal 200 is plugged into the plug-in groove 23, the stresses on both sides of the mating terminal 200 are corresponding to each other to achieve a better clamping effect.

In an embodiment, as illustrated in FIGS. 4 and 5, the cantilevers 122 in the laminated terminal 10 are symmetrically disposed. Therefore, when the mating terminal 200 is plugged into the plug-in groove 23, the stresses on both sides of the mating terminal 200 are corresponding to each other to achieve a better clamping effect.

In an embodiment, as illustrated in FIGS. 1 to 7, the cantilever 122 extends from a free end of the plug-in arm 12 toward the laminate base body 11. A direction in which the cantilever 122 extends from the free end of the plug-in arm 12 toward the laminate base body 11 is a direction in which the mating terminal 200 is plugged into the plug groove 23. Therefore, in practical application, the failure of the cantilever 122 caused by the oblique plug-in of the mating terminal 200 is avoided, thereby avoiding the poor electrical contact between the plug-in terminal 100 and the mating terminal 200.

In an embodiment, as illustrated in FIG. 5, a bent portion 1221 is disposed on a side at the free end of the cantilever 122, and an outer side of the bent portion 1221 faces the plug-in space 13.

By disposing the bent portion 1221 on the cantilever 122, the clamping force of the laminated terminal 10 to the mating terminal 200 can be increased when the plug-in terminal 100 is plugged into the mating terminal 200. The outer side of the bent portion 1221 is a protruding side.

In an embodiment, a minimum distance between the bent portions 1221 on the paired plug-in arms 12 is less than or equal to a minimum distance between the contact portions 121 on the paired plug-in arms 12. A minimum distance between two opposite bent portions 1221 in a free state is less than or equal to a minimum distance between two opposite contact portions 121 in a free state, so that the cantilever 122 can generate a better clamping force for the mating terminal 200 when the mating terminal 200 is plugged into the plug-in groove 23.

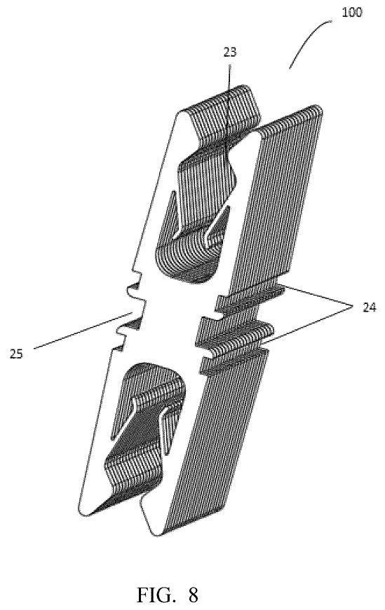

In an embodiment, as illustrated in FIGS. 1 to 3, one end of each of the laminate base bodies 11 includes at least one pair of buckle recesses 14 which are oppositely disposed. As illustrated in FIG. 8, the buckle recesses 14 of the plurality of laminate base bodies 11 are stacked in the transverse direction to form corresponding buckle grooves 24. As illustrated in FIG. 3, the plug-in terminal 100 further includes at least one pair of first buckles 30. As illustrated in FIG. 9, the first buckle 30 includes a fixing portion 301 and holding portions 302 disposed at two ends of the fixing portion 301: the fixing portions 301 of one pair of the first buckles 30 are respectively buckled in the corresponding buckle grooves 24, and the holding portions 302 of at least one pair of the first buckles 30 are mutually clamped to fix the plurality of laminated terminals 10 together.

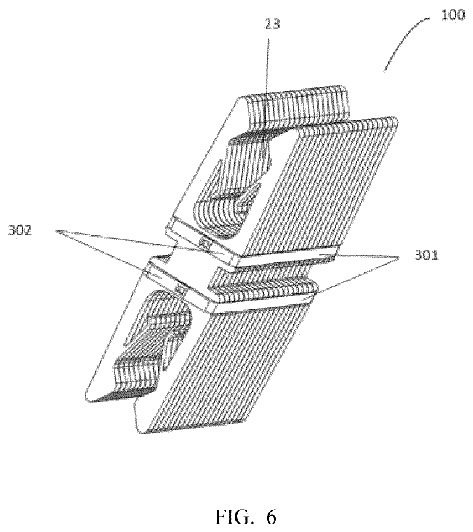

As illustrated in FIG. 3, one pair of the first buckles 30 may be cooperated with the plug-in terminal with one pair of the buckle grooves 24, or as illustrated in FIG. 6, the plug-in terminal 100 includes two pairs of buckle grooves 24, with which two pairs of first buckles 30 are cooperated respectively to fix the plurality of laminated terminals 10 together.

The first buckle 30 is made of a plastic material or any other hard material.

In an embodiment, as illustrated in FIGS. 13 and 14, when the mating terminal 200 is plugged into the plug-in terminal 100, the plug-in arm 12 stretches, and a tension on the laminate base body 11 will be transferred through the first buckle 30. By disposing the first buckle 30, the plug-in arm 12 can be supported to avoid the failure of the plug-in terminal 100 caused by excessive plug-in and unplug-in of the mating terminal 200.

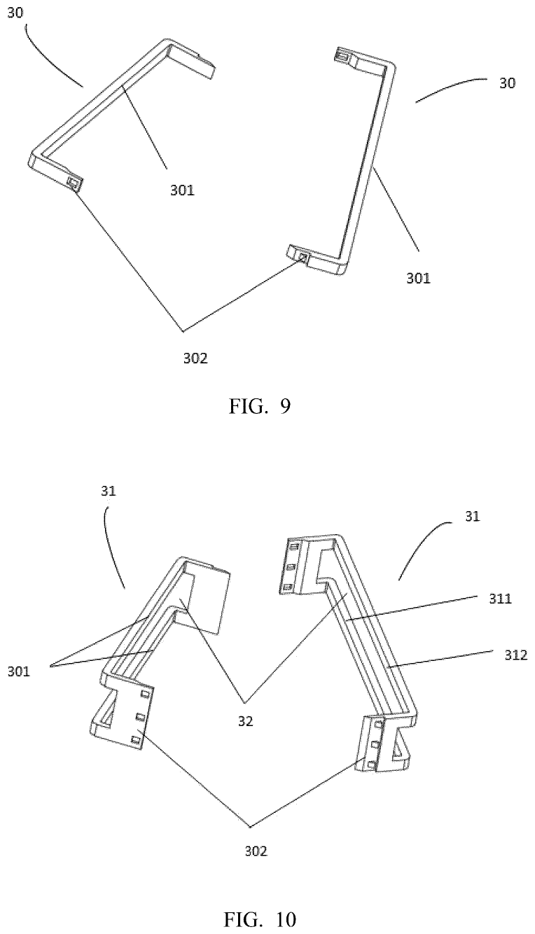

In an embodiment, as illustrated in FIGS. 4 to 6 and 7, two ends of each of the laminate base bodies 11 are respectively provided with opposite buckle recesses 14. As illustrated in FIG. 8, two pairs the of buckle recesses 14 of the plurality of laminate base bodies 11 are stacked in the transverse direction to form the corresponding buckle grooves 24, a fixing recess 15 is further disposed between the buckle recesses 14 at the two ends of each of the laminate base bodies 11, and the fixing recesses 15 of the plurality of laminate base bodies 11 are stacked in the transverse direction to form a fixing groove 25. As illustrated in FIG. 10, the plug-in terminal 100 further includes a pair of second buckles 31, each of which includes a fixing portion 301 and holding portions 302 disposed at two ends of the fixing portion 301, in which the fixing portion 301 has a hollow structure 32 that divides the fixing portion 301 into a first fixing portion 311 and a second fixing portion 312 which are respectively buckled in the corresponding buckle grooves 24, and the holding portions 302 on the same side of one pair of the second buckles 31 are clamped with each other to fix the plurality of laminated terminals 10 together, and in which the fixing groove 25 is exposed through the hollow structure 32.

The second buckle 31 is made of a plastic material or any other hard material.

An embodiment of a second aspect of the present disclosure provides a plug-in terminal mounting structure, including fixing sidewalls 40 which are oppositely disposed and a plug-in terminal 100, in which inner sides of the fixing sidewall 40 are respectively provided with extended elastic pieces 41, ends of the elastic pieces 41 are respectively provided with protruding fixing blocks 42, and the fixing blocks 42 are cooperatively connected to the fixing groove 25.

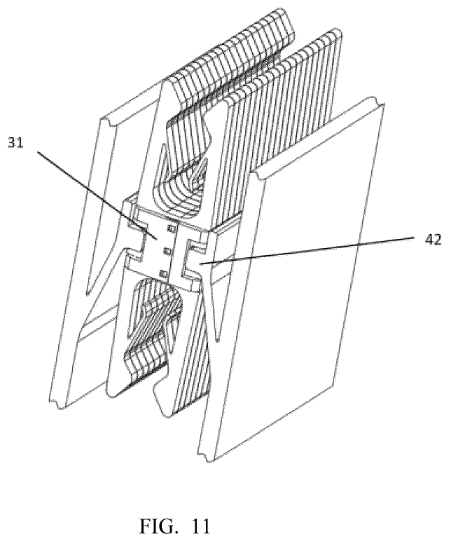

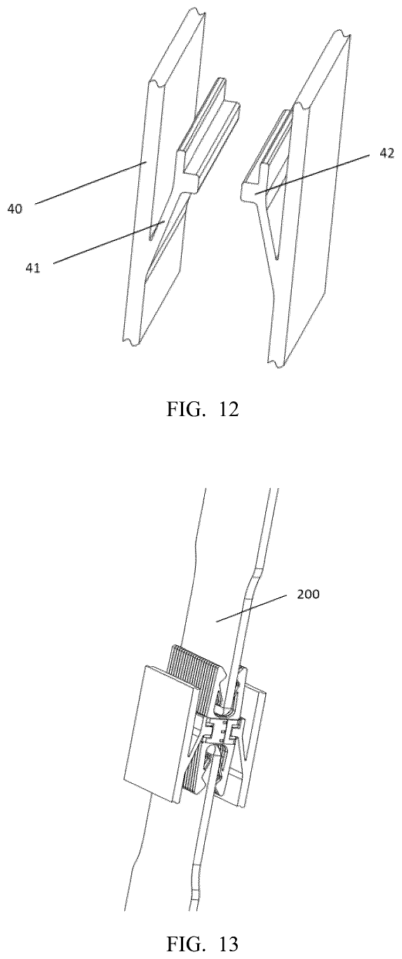

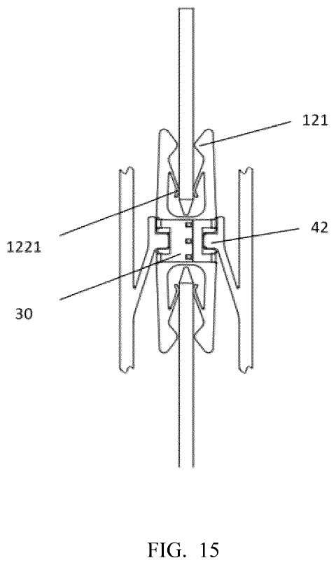

Since the inner side of the fixing sidewall 40 is provided with the elastic piece 41, when the mating terminal 200 is plugged into the plug-in terminal 100, the elastic piece 41 contracts, so that the fixing groove 25 also contracts, thereby fixing and supporting the plug-in terminal 100. The plug-in terminal 100 is cooperated with the fixing block 42 of the elastic piece 41, and is detachable during mounting due to the elastic effect of the elastic piece 41. In the directions as illustrated in FIGS. 11 and 12, the plug-in terminal 100 is mounted to the fixing sidewall 40 from bottom to top, and the plug-in terminal 100 can be easily plugged between two opposite fixing sidewalls 40 due to the elastic effect of the elastic piece 41, so that the fixing block 42 can be successfully plugged into the fixing groove 25, thereby saving the cost of the later maintenance. As illustrated in FIGS. 13 to 15, after the plug-in terminal 100 is mounted on an insulator, it can be plugged into the mating terminal 200 in the directions of 90° and 180°, and a plug-in direction is from top to bottom, thereby achieving the adaption with the high-current mating terminal 200.

Those described above are only several embodiments of the present disclosure, and those skilled in the art can make various modifications or variations to the embodiments of the present disclosure according to the application document without departing from the spirit and scope of the present disclosure. It should be understood that the orientations or positional relationships indicated by the terms “length”, “width”, “upper”, “lower”, “front”, “rear”, “left”, “right”, “vertical”, “horizontal”, “top”, “bottom”, “inner”, “outer”, etc. are based on those illustrated in the drawings, merely for the convenience of describing the present disclosure and simplifying the description, rather than indicating or implying that a device or element referred to must have a particular orientation or must be constructed and operated in a particular orientation, and hence cannot be construed as limitations to the present disclosure.

In addition, the terms “first”, “second”, “third” and “fourth” are used for descriptive purposes only, and cannot be understood as indicating or implying relative importance or implicitly indicating the number of the technical features referred to.

In the present disclosure, unless otherwise expressly specified and limited, a term such as “mount”, “connect”, “fix” or the like should be broadly understood, and for example, it may be a fixed connection, a detachable connection, an integration, a mechanical connection, an electrical connection, a direct connection, an indirect connection through an intermediate medium, or a communication between the interiors of two elements, or an interactive relationship between two elements. For those skilled in the art, the specific meanings of the above terms in the present disclosure can be understood according to specific situations.

1. A plug-in terminal comprising a plurality of laminated terminals stacked in a transverse direction, wherein each of the laminated terminals comprises:
a laminate base body and plug-in arms longitudinally extending from one end of the laminate base body and disposed to be paired, with a plug-in space formed between the paired plug-in arms; and
a contact portion protruding toward the plug-in space and a protruding cantilever with elastic are sequentially disposed from a free end of the plug-in arm to the laminate base body,
wherein a plurality of the plug-in spaces are stacked in the transverse direction to form a plug-in groove, and the plug-in groove is configured to interface with a mating terminal to realize an electrical connection between the plug-in terminal and the mating terminal.

2. The plug-in terminal according to claim 1, wherein each of the laminated terminals further comprises the plug-in arms extending longitudinally from the other end of the laminate base body and disposed to be paired.

3. The plug-in terminal according to claim 1, wherein the contact portions on the paired plug-in arms in the laminated terminal are symmetrically disposed.

4. The plug-in terminal according to claim 1, wherein the cantilevers on the paired plug-in arms in the laminated terminal are symmetrically disposed.

5. The plug-in terminal according to claim 1, wherein the cantilever extends from a free end of the plug-in arm toward the laminate base body.

6. The plug-in terminal according to claim 5, wherein a bent portion is disposed on a side at the free end of the cantilever, and an outer side of the bent portion faces the plug-in space.

7. The plug-in terminal according to claim 6, wherein a minimum distance between the bent portions on the paired plug-in arms is less than or equal to a minimum distance between the contact portions on the paired plug-in arms.

8. The plug-in terminal according to claim 1, wherein one end of each of the laminate base bodies comprises at least one pair of buckle recesses which are oppositely disposed; the buckle recesses of the plurality of laminate base bodies are stacked in the transverse direction to form corresponding buckle groove; the plug-in terminal further comprises at least one pair of first buckles, the first buckle comprising a fixing portion and holding portions disposed at two ends of the fixing portion; the fixing portions of one pair of the first buckles are respectively buckled in the corresponding buckle grooves; and the holding portions of at least one pair of the first buckles are mutually clamped to fix the plurality of laminated terminals together.

9. The plug-in terminal according to claim 1, wherein:
two ends of each of the laminate base bodies are respectively provided with opposite buckle recesses, a fixing recess is further disposed between the buckle recesses at the two ends of each of the laminate base bodies, two pairs the of buckle recesses of the plurality of laminate base bodies are stacked in the transverse direction to form corresponding buckle grooves, and the fixing recesses of the plurality of laminate base bodies are stacked in the transverse direction to form a fixing groove; and
the plug-in terminal further comprises a pair of second buckles, each of the second buckles comprises a fixing portion and holding portions disposed at two ends of the fixing portion, and the fixing portion has a hollow structure that divides the fixing portion into a first fixing portion and a second fixing portion which are respectively buckled in the corresponding buckle grooves, the holding portions on the same side of one pair of the second buckles are clamped with each other to fix the plurality of laminated terminals together, and the fixing groove is exposed through the hollow structure.

10. A plug-in terminal mounting structure, wherein comprising fixing sidewalls which are oppositely disposed and the plug-in terminal according to claim 1, inner sides of the fixing sidewalls are respectively provided with extended elastic pieces, ends of the elastic pieces are respectively provided with protruding fixing blocks, and the fixing blocks are cooperatively connected to the fixing groove.

11. The plug-in terminal mounting structure according to claim 10, wherein each of the laminated terminals further comprises the plug-in arms extending longitudinally from the other end of the laminate base body and disposed to be paired.

12. The plug-in terminal mounting structure according to claim 10, wherein the contact portions on the paired plug-in arms in the laminated terminal are symmetrically disposed.

13. The plug-in terminal mounting structure according to claim 10, wherein the cantilevers on the paired plug-in arms in the laminated terminal are symmetrically disposed.

14. The plug-in terminal mounting structure according to claim 10, wherein the cantilever extends from a free end of the plug-in arm toward the laminate base body.

15. The plug-in terminal mounting structure according to claim 14, wherein a bent portion is disposed on a side at the free end of the cantilever, and an outer side of the bent portion faces the plug-in space.

16. The plug-in terminal mounting structure according to claim 15, wherein a minimum distance between the bent portions on the paired plug-in arms is less than or equal to a minimum distance between the contact portions on the paired plug-in arms.

17. The plug-in terminal mounting structure according to claim 10, wherein one end of each of the laminate base bodies comprises at least one pair of buckle recesses which are oppositely disposed; the buckle recesses of the plurality of laminate base bodies are stacked in the transverse direction to form corresponding buckle groove; the plug-in terminal further comprises at least one pair of first buckles, the first buckle comprising a fixing portion and holding portions disposed at two ends of the fixing portion; the fixing portions of one pair of the first buckles are respectively buckled in the corresponding buckle grooves; and the holding portions of at least one pair of the first buckles are mutually clamped to fix the plurality of laminated terminals together.

18. The plug-in terminal mounting structure according to claim 10, wherein:
two ends of each of the laminate base bodies are respectively provided with opposite buckle recesses, a fixing recess is further disposed between the buckle recesses at the two ends of each of the laminate base bodies, two pairs the of buckle recesses of the plurality of laminate base bodies are stacked in the transverse direction to form corresponding buckle grooves, and the fixing recesses of the plurality of laminate base bodies are stacked in the transverse direction to form a fixing groove; and
the plug-in terminal further comprises a pair of second buckles, each of the second buckles comprises a fixing portion and holding portions disposed at two ends of the fixing portion, and the fixing portion has a hollow structure that divides the fixing portion into a first fixing portion and a second fixing portion which are respectively buckled in the corresponding buckle grooves, the holding portions on the same side of one pair of the second buckles are clamped with each other to fix the plurality of laminated terminals together, and the fixing groove is exposed through the hollow structure.
